(19) United States
(12) Patent Application Publication
(10) Pub. No.: US 2008/0230579 A1
(43) Pub. Date: Sep. 25, 2008

(54) Bicycle rack with wheel securing devices

(76) Inventor: Chiu-Kuei Wang, Dajia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,106

(22) Filed: May 1, 2007

(30) Foreign Application Priority Data
Mar. 23, 2007 (TW) 095207487

(51) Int. Cl. B60R 9/10

(52) U.S. Cl. 224/400

(57) ABSTRACT

A bicycle rack a frame and two side rods pivotably connected to two sides of the frame and two wheel securing devices are connected to the two side rods respectively. Each wheel securing device includes a wheel retaining units which has a U-shaped member with which the front wheel or the rear wheel is retained. A post is pivotably connected to a top of the frame and a frame securing unit is connected to the post so as to position the bicycle frame.

### FIELD OF THE INVENTION

The present invention relates to a bicycle rack with wheels securing devices for secure wheels of the bicycles on the bicycle rack.

### BACKGROUND OF THE INVENTION

A conventional bicycle rack is connected to a rear end of a vehicle and generally includes a connection end which is connected with a hinge at the rear end of the vehicle and an L-shaped post includes a plurality of securing members for securing bicycle frames thereto. Another conventional bicycle rack uses hooks and belts to hook the bicycle rack on the hatch back of the vehicle. Two support arms extend from the rack so as to support bicycle thereon. Fastening members are used to fasten the bicycle on the support arms. Both of the conventional bicycle racks can carry multiple bicycles. However, neither of the conventional bicycle racks can secure the wheels so that the front and rear wheels of the bicycles are freely rotated during transportation and the wheels usually hit the vehicle to generate noise and the fastening or securing members are easily loosened.

The present invention intends to provide a bicycle rack for vehicle wherein the front and rear wheels of the bicycles are secured on the wheel retaining members.

### SUMMARY OF THE INVENTION

The present invention relates to a bicycle rack which comprises a connection portion including a frame on a first end thereof and a second end of the connection portion is connected with a connection tube on a vehicle by a securing unit. Two side rods are pivotably connected to two sides of the frame and two wheel securing devices are connected to the two side rods respectively. Each wheel securing device includes a wheel retaining units which has a U-shaped member so as to position front or rear wheel of the bicycle. A post is pivotably connected to a top of the frame and a frame securing unit is connected to the post. The frame securing unit includes a securing member which is movably connected to the post so as to position the bicycle frame from a top of the bicycle.

The primary object of the present invention is to provide a bicycle rack that includes two wheel retaining units for positioning the wheels of the bicycle such that the wheels are not rotated during transportation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rack of the present invention;

FIG. 2 is an exploded view to show the connection portion and the securing unit of the present invention, and the connection tube on a vehicle;

FIG. 3 shows the connection of the frame and the two side rods and the post of the bicycle rack of the present invention;

FIG. 4 shows the wheel retaining unit movable on the side rod;

FIG. 5 shows the bicycle rack is folded;

FIG. 6 shows the frame securing unit is movable on the post;

FIG. 7 shows the bicycle is positioned on the bicycle rack, and

FIG. 8 shows that the post is pivoted to horizontal direction.

### DETAILED DESCRIPTION OF THE PREFERRED EMBODIMENT

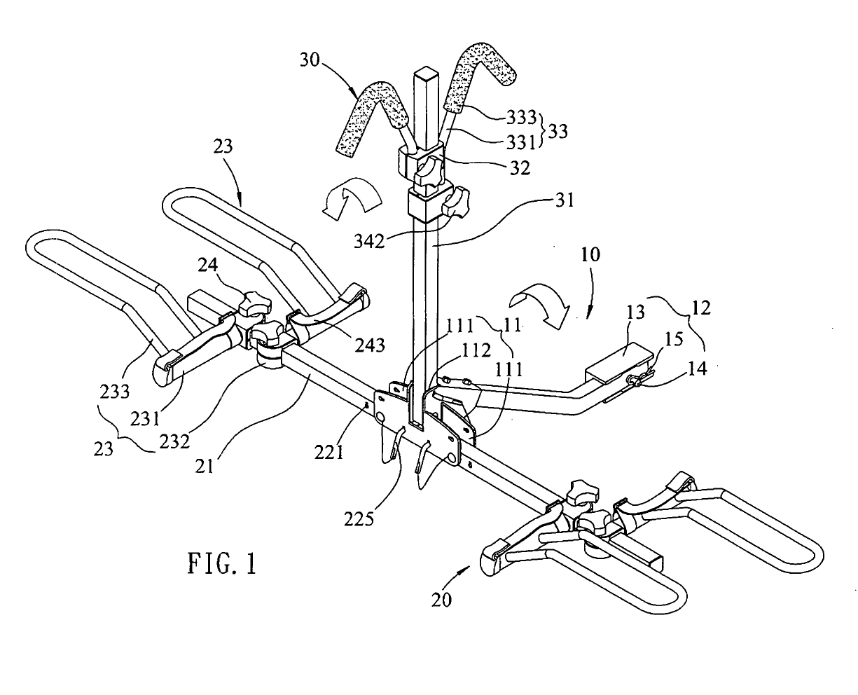

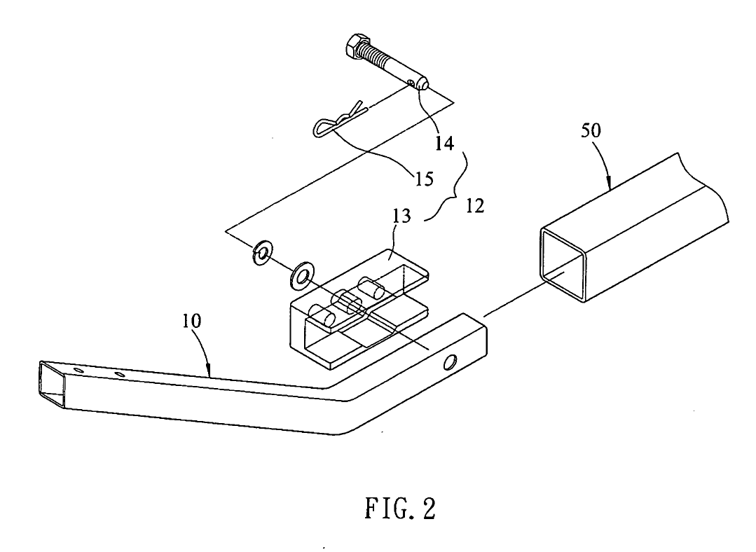

Referring to FIGS. 1 to 3, the bicycle rack of the present invention comprises a connection portion 10 including a frame 11 on a first end thereof and a second end of the connection portion 10 is connected with a connection tube 50 on a vehicle (not shown) by a securing unit 12. The securing unit 12 includes a U-shaped member 13 mounted to the second end of the connection portion 10 and the connection tube 50 is mounted to the second end of the connection portion 10. A pin 14 extends through the U-shaped member 13, the connection tube 50 and the second end of the connection portion 10 so as to connect the bicycle rack to the vehicle.

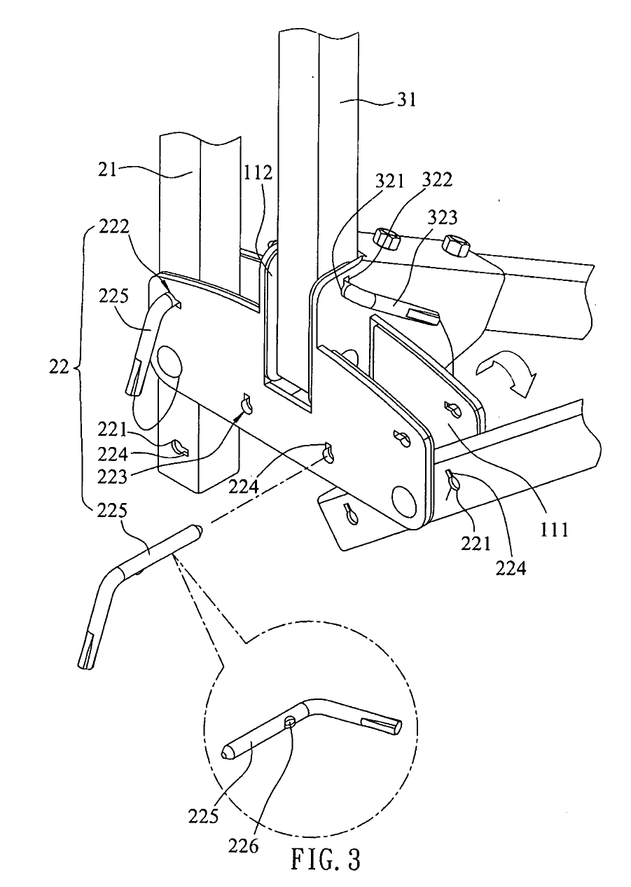

The frame 11 includes two side recesses 111 on two sides thereof and a top recess 112 is defined in a top of the frame 11. Each of the two side recesses 111 is composed of two sidewalls and two side rods 21 are pivotably connected to the two side recesses 111 of the frame 11 by a positioning arrangement 22. Two wheel securing devices 20 are connected to the two side rods 21 respectively and each wheel securing device 20 includes a wheel retaining units 23 which has a U-shaped member 233. The positioning arrangement 22 includes a first hole 222 and a second hole 223 defined in each of the sidewalls, and each of the two side rods 21 includes two positioning holes 221. One of the two positioning holes 221 is aligned with one of the first and second holes 222, 223, an L-shaped pin 225 extends through the aligned positioning hole 221 and one of the first and second holes 222, 223. Each of first and second holes 222, 223 and the positioning holes 221 communicates with respective one of notches 224 and the pin 225 includes a protrusion 226 which extends through the notches 224 and the pin 225 is rotated angle to move the protrusion 226 away from the notches 224. It is noted that as shown in FIG. 3, when the side rods 21 are located at horizontal positions, the pin 225 extends through the second holes 223 and one of the positioning holes 221. When the sides rods 21 are pivoted upward, the pin 225 extends through the first holes 222 and one of the positioning holes 221.

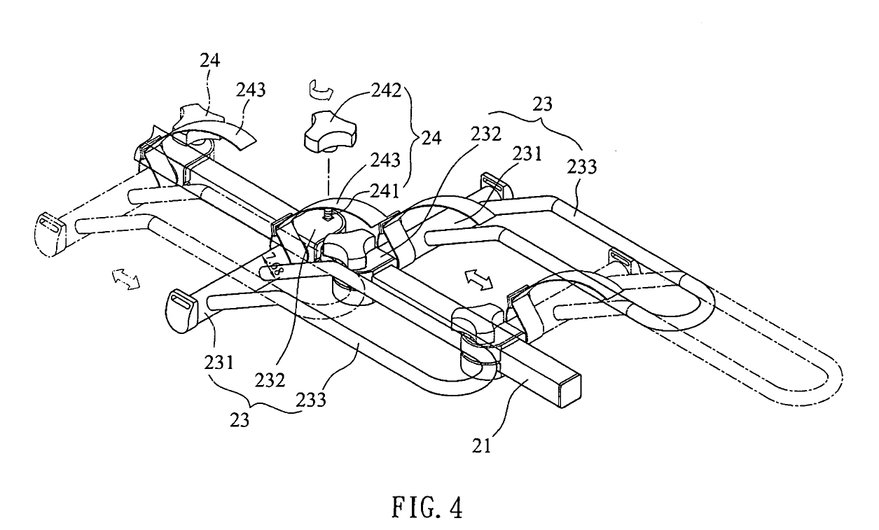

Referring to FIG. 4, the wheel retaining units 23 of each of the wheel securing devices 20 includes a bar 231, a locking set 232 connected to an end of the bar 231 and the U-shaped member 233 extending from the bar 231. The locking set 232 is cooperated with a locking assembly 24 which includes two clamping members so as to clamp the side rod 21 therebetween and a threaded rod 241 extend through the two clamping members. A knob 242 is threadedly connected to the threaded rod 241 to secure the locking set 232 at desired position on the side rod 21. Therefore, the U-shaped member 233 is movable on the side rod 21 to adjust the distance between the two U-shaped members 233 on the two side rods 21 to fit bicycles of different sizes. A securing belt 243 is mounted to the bar 231 to further tie the bicycle wheel.

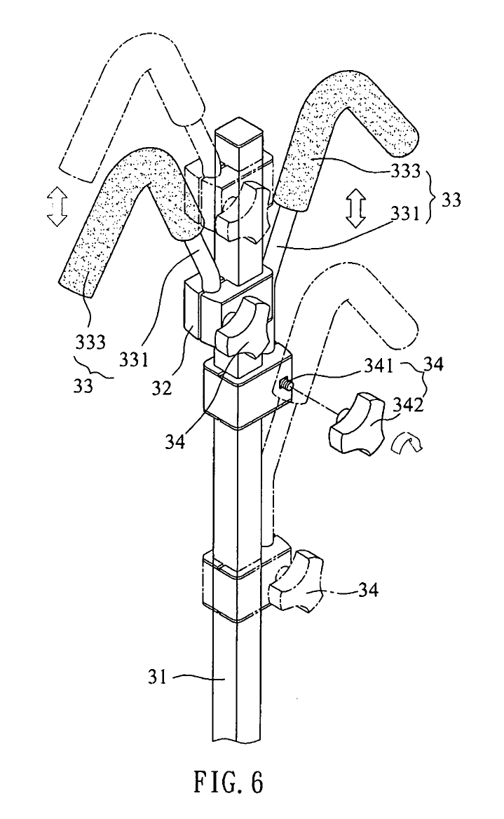

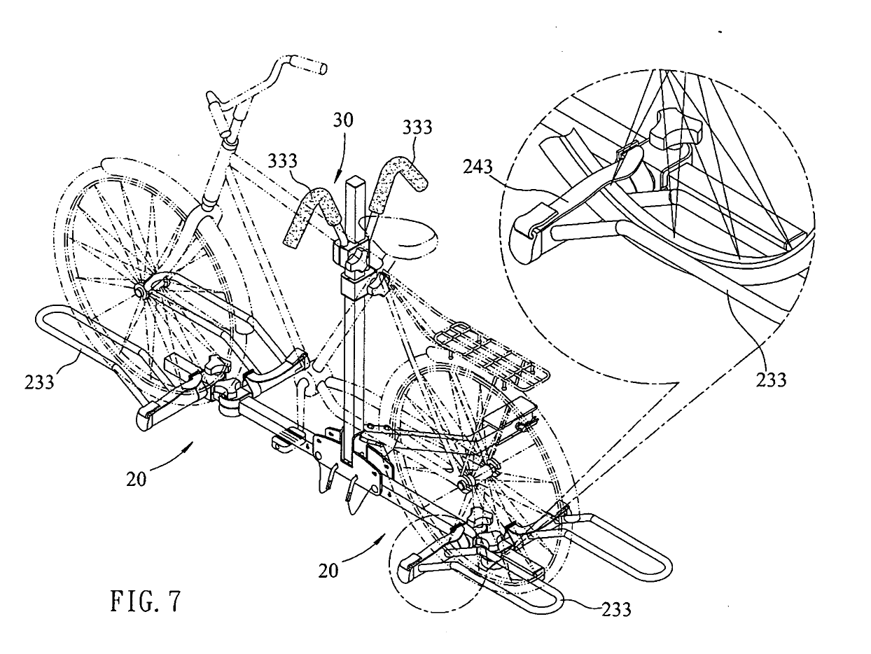

A post 31 is pivotably engaged with the top recess 112 which is composed of two sidewalls and a positioning hole 321 is defined through each of the two sidewalls. An L-shaped pin 323 extends through the positioning holes 321 and the post 31. Each of the positioning hole 321 communicates with a notch 322 and the pin 323 includes a protrusion (not shown) which extends through the notches 322 and the pin 323 is rotated angle to move the protrusion away from the notches 322. A frame securing unit 30 is connected to the post 31 and includes a securing member 33 which is movably connected to the post 31. A locking set 32 is movably mounted to the post 31 and a securing member 33 is connected to the locking set 32. The securing member 33 includes a rod 331 and a hook 333. The locking set 32 is cooperated with a positioning set 34 which includes a threaded rod 341 extending through two clamping members of the locking set 32 and a knob 342 is threadedly connected to the threaded rod 341. The hook 333 is lowered to hook on the bicycle frame to further position the bicycle as shown in FIGS. 6 and 7.

Accordingly, the bicycle can be well secured on the bicycle rack and the wheels of the bicycle are positioned in the U-shaped members 233. The hook 333 applies a downward force to set the bicycle on the bicycle rack.

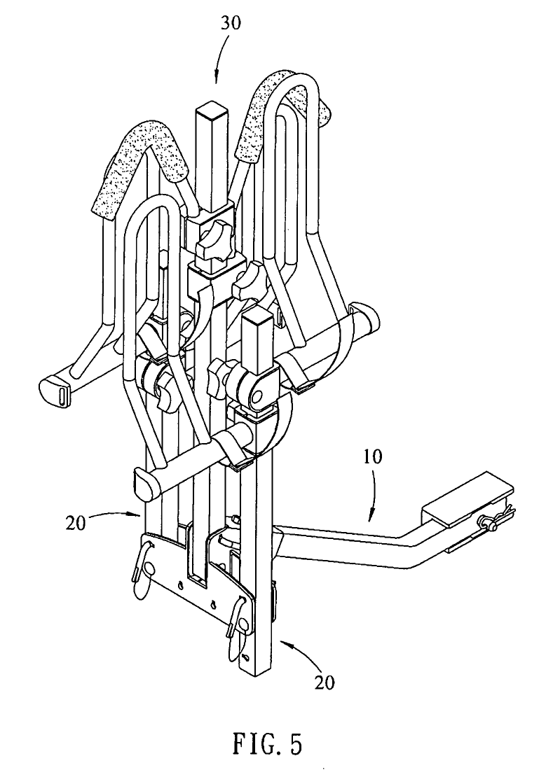

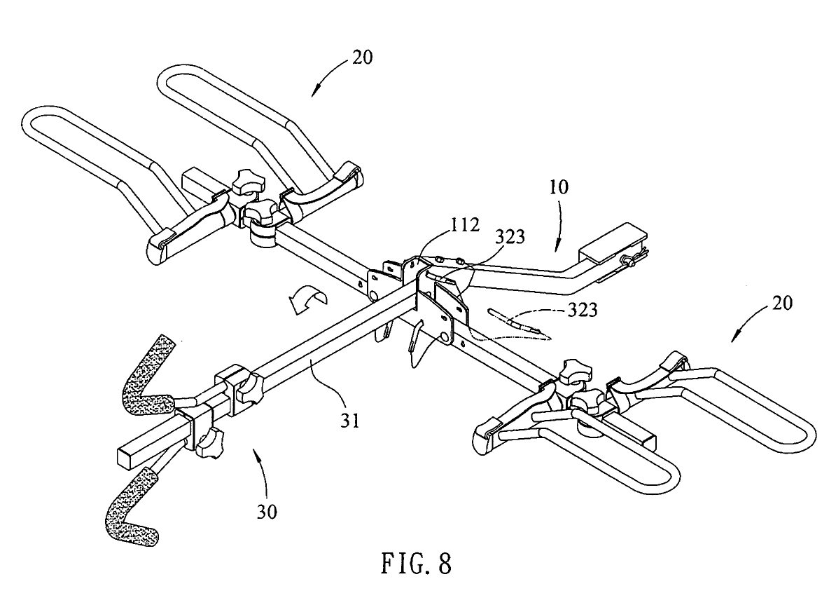

As shown in FIG. 5, when the bicycle rack is not in use, the two side rods 21 can be pivoted upward so that the bicycle rack is compact and easily to be stored. As shown in FIG. 8, another way to store the bicycle rack is simply pivoting the post 31 to horizontal position and the whole bicycle rack is flat and can be stored in the vehicle trunk without occupying too much space.

While we have shown and described the embodiment in accordance with the present invention, it should be clear to those skilled in the art that further embodiments may be made without departing from the scope of the present invention.

What is claimed is:

1. A bicycle rack comprising:
a connection portion (10) including a frame (11) on a first end thereof and a second end of the connection portion (10) adapted to be connected with a connection tube (50) on a vehicle by a securing unit (12);
two side rods (21) pivotably connected to two sides of the frame (1) and two wheel securing devices (20) connected to the two side rods (21) respectively, each wheel securing device (20) including a wheel retaining units (23) which has a U-shaped member (233), and
a post (31) pivotably connected to a top of the frame (11) and a frame securing unit (30) connected to the post (31), the frame securing unit (30) including a securing member (33) which is movably connected to the post (31).

2. The bicycle rack as claimed in claim 1, wherein the securing unit (12) includes a U-shaped member (13) mounted to the second end of the connection portion (10) and a pin (14) extends through the U-shaped member (13) and the second end of the connection portion (10) so as to be adapted to connect the connection tube (50).

3. The bicycle rack as claimed in claim 1, wherein the wheel retaining units (23) of each of the wheel securing devices (20) includes a bar (231), a locking set (232) connected to an end of the bar (231) and the U-shaped member (233) extending from the bar (231), the locking set (232) is movably connected to the side rod (21).

4. The bicycle rack as claimed in claim 3, wherein the locking set (232) is cooperated with a locking assembly (24) which includes two clamping members so as to clamp the side rod (21) therebetween and a threaded rod (241) extend through the two clamping members, a knob (242) is threadedly connected to the threaded rod (241).

5. The bicycle rack as claimed in claim 3 further comprising a securing belt (243) mounted to the bar (231).

6. The bicycle rack as claimed in claim 1, wherein the frame securing unit (30) includes a locking set (32) which is movably mounted to the post (31) and a securing member (33) is connected to the locking set (32), the securing member (33) includes a rod (331) and a hook (333).

7. The bicycle rack as claimed in claim 6, wherein the locking set (32) is cooperated with a positioning set (34) which includes a threaded rod (341) extending through two clamping members of the locking set (32) and a knob (342) is threadedly connected to the threaded rod (341).

8. The bicycle rack as claimed in claim 1, wherein the frame (11) includes two side recesses (111) and a top recess (112), the two side rods (21) are pivotably engaged with the two side recesses (111) and positioned by a positioning arrangement (22), the post (31) is pivotably engaged with the top recess (112).

9. The bicycle rack as claimed in claim 8, wherein each of the two side recesses (111) is composed of two sidewalls and the positioning arrangement (22) includes a first hole (222) and a second hole (223) defined in each of the sidewalls, each of the two side rods (21) includes two positioning holes (221), one of the two positioning holes (221) is aligned with one of the first and second holes (222, 223), a pin (225) extends through the aligned positioning hole (221) and one of the first and second holes (222, 223).

10. The bicycle rack as claimed in claim 9, wherein each of first and second holes (222, 223) and the positioning holes (221) communicates with respective one of notches (224) and the pin (225) is an L-shaped pin which includes a protrusion (226) which extends through the notches (224) and the pin (225) is rotated angle to move the protrusion (226) away from the notches (224).

11. The bicycle rack as claimed in claim 8, wherein the top recess (112) is composed of two sidewalls and a positioning hole (321) is defined through each of the two sidewalls, a pin (323) extends through the positioning holes (321) and the post (31).

12. The bicycle rack as claimed in claim 11, wherein each of the positioning hole (321) communicates with a notch (322) and the pin (323) is an L-shaped pin which includes a protrusion which extends through the notches (322) and the pin (323) is rotated angle to move the protrusion away from the notches (322).
